(19) United States
(12) Patent Application Publication
(10) Pub. No.: US 2007/0214338 A1
(43) Pub. Date: Sep. 13, 2007

(54) Optimization method for storage region allocation, and management computer for implementing the same

(75) Inventors: Jun Mizuno, Yokohama (JP); Masayuki Yamamoto, Sagamihara (JP); Yuichi Taguchi, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd. Incorporation:, Tokyo (JP)

(21) Appl. No.: 11/410,778

(22) Filed: Apr. 24, 2006

(30) Foreign Application Priority Data
Mar. 8, 2006 (JP) 2006-062139

(51) Int. Cl. G06F 12/00

(52) U.S. Cl. 711/170

(57) ABSTRACT

A storage system has a pool which is made up of a plurality of storage regions supplied by physical disks, and allocates the storage regions within this pool to volumes supplied to host computers, and cancels such allocations. When a volume addition event has occurred, a management computer forecasts, for each volume, the capacity which is to be required at a certain time point in the future, based on usage capacities acquired for each volume, calculates a non-required capacity from this capacity which has been forecast and the capacities of the storage region groups which are already allocated to the volume, decides, based on one or more non-required capacities which have been calculated, whether or not there is a storage region enough to satisfy the capacity requested for a volume which is the object of addition, and, if a positive decision result is obtained, allocates storage regions equivalent to the non-required capacity to the volume which is the object of addition.

### CROSS-REFERENCE TO RELATED APPLICATION(S)

This application relates to and claims priority from Japanese Patent Application No. 2006-62139 filed on Mar. 8, 2006, the entire disclosure of which is hereby incorporated herein by reference.

### BACKGROUND

The present invention relates to a technique for allocating storage regions for logical volumes which are supplied to a host computer.

Generally, a computer system comprises one or more host systems for performing specified tasks and a storage system which reads and writes data according to commands from the host computer. Such a storage system comprises a plurality of physical storage devices (for example hard disk drives; hereinafter termed, for the sake of convenience, “physical disks”). the storage system may divide these physical disks into a plurality of storage regions and manage these storage regions. Furthermore, the storage system may supply to the host computers so-called logical storage devices termed logical volumes (hereinafter “volumes”). A volume is made up of a plurality of segments, and, by allocating a storage region on a physical disk to each of these segments, it becomes possible for data to be read and written according to commands from the computers. And, according to requirements, it is possible to extend the capacity of a volume temporarily.

For example, in Japanese Patent Laid-Open Publication 2003-15915, there is disclosed a method for automatically extending the capacity of a volume. In concrete terms a method is disclosed in which, if there is a shortfall in the capacity of a volume due to writing from a host computer, the storage system automatically adds, as a segment of the volume, a storage region on the physical disk which is unused.

On the other hand, for example, in Japanese Patent Laid-Open Publication 2005-38071, a management method is disclosed for optimizing the capacity for storage. In concrete terms, a management method is disclosed in which the usage capacities of the storage devices which have been allocated to the host computers are acquired, the usage capacities from the present moment onwards are forecast from these acquired capacities, and appropriate capacities to be allocated are calculated from these forecast usage capacities; and if the capacity to be allocated which has thus been calculated is greater than the upper limit capacity, the storage device which has been already allocated is returned to a storage pool and then another storage device, whose capacity is greater than or equal to the lower limit capacity but less than or equal to the upper limit capacity, is allocated to the host computer.

### SUMMARY

The storage capacities which are actually used by the host computers (in other words the usage capacities) may vary along with the passage of time, i.e. may increase or decrease. Due to this, it might be considered to be desirable to anticipate such increases, and to allocate large storage capacities. However, indefinitely continuing to allocate storage capacity which is never used engenders useless wastage of storage resources.

Furthermore, for example, it sometimes happens that, according to requirements, a physical disk may be added to the storage system. If a physical disk is thus added, naturally the storage capacity of the entire storage system increases. No description of any consideration being given to this type of addition of a physical disk is disclosed in either of the above described publications. It is considered that it will be possible to allocate storage resources more appropriately, if allocation of storage capacity is performed in consideration of the possible addition of one or more physical disks.

Accordingly, an object of the present invention is to optimize the allocation of storage regions, so that useless allocation of storage regions to volumes for the host computers is suppressed as much as possible. Desirably, this optimization should be performed while taking into consideration the possible addition of one or more physical disks.

Other objects of the present invention will become clear from the following description.

There are one or a plurality of host computers which transmit 10 commands for logical volumes which are supplied to the host computers. Furthermore, there is a storage system which comprises a plurality of logical volumes which are supplied to the one or a plurality of host computers, a plurality of physical storage devices, a pool which is made up of a large number of storage regions based on the plurality of physical storage devices, and a controller which allocates storage regions within the pool to logical volumes and cancels such allocations, and writes data according to IO commands for logical volumes which have been specified by the one or a plurality of host computers into storage regions which have been allocated to the logical volumes, or reads out data from the storage regions and transmits the data to the one or a plurality of host computers.

A management computer is communicably connected to the one or a plurality of host computers and to the storage system, and includes: a usage capacity reception unit which, for each of the logical volumes, from at least one of the host computer and the storage system, at a plurality of different time points, receives usage capacity, which is the storage capacity actually used by the host computer, from among the allocated capacity, which is the storage capacity of one or more storage regions which are allocated to the logical volume; a remaining capacity reception unit which receives, from the storage system, a pool remaining capacity, which is the storage capacity of one or more storage regions which are not allocated to the logical volume, among the large number of storage regions of the pool; a forecasting unit which, when an event of addition of a logical volume has occurred, forecasts, for at least one logical volume, the usage capacity of the logical volume at a certain time point in the future, based on a plurality of usage capacities which have been respectively received at the plurality of time points; a non-required capacity calculation unit which calculates, for at least one logical volume, a non-required capacity, which is the storage capacity that will not be required at the certain time point, by subtracting from the allocated capacity of the logical volume a required capacity, which is the usage capacity which has been forecast; a decision unit which, based on the pool remaining capacity which has been received and on the non-required capacity which has been calculated, decides whether or not a requested capacity, which is the storage capacity requested for a logical volume which is the object of addition, is satisfied; and a command unit which, if a positive decision result is obtained, commands the storage system to cancel storage region allocation equivalent to the non-required capacity which has been calculated, and to allocate storage regions equivalent to the requested capacity and including storage regions of which the allocation is cancelled, to the logical volume which is the object of addition.

In a first embodiment, the certain time point may be a time point at which the physical storage device is to be additionally provided.

In a second embodiment, the management computer may further include: an addition time point calculation unit which, if a negative decision result is obtained, calculates another time point in the future at which the requested capacity is to be satisfied as an addition time point which is the time point at which the physical storage device is to be additionally provided; and an addition time point notification unit which notifies the calculated addition time point to a manager.

In a third embodiment, the management computer may further include another decision unit which decides whether or not the accuracy of the forecast required capacity is greater than or equal to a predetermined accuracy. In this case, this non-required capacity calculation unit may use the required capacity of which the accuracy is greater than or equal to the predetermined accuracy when calculating the non-required capacity without using the required capacity of which the accuracy is less than the predetermined accuracy.

In a fourth embodiment, a plurality of pools may be provided in the storage system, and the command unit may preferentially cancel the allocation of storage regions equivalent to the non-required capacity within the same pool, and may allocate the storage regions to the logical volume which is the object of addition.

In a fifth embodiment, the command unit may preferentially cancel the allocation of storage regions equivalent to the non-required capacity, from that logical volume whose non-required capacity is the largest, and may allocate the storage regions to the logical volume which is the object of addition.

In a sixth embodiment, a plurality of pools may be provided within the storage system, and the command unit may preferentially cancel an allocation equivalent to the non-required capacity from storage regions which are allocated to that logical volume whose non-required capacity is the largest, among the storage regions within the same pool, and may allocate the storage regions to the logical volume which is the object of addition.

In a seventh embodiment, a plurality of pools may be provided within the storage system, and when canceling a storage region allocation equivalent to the non-required capacity within two or more pools from among the plurality of pools and allocating the storage regions to the logical volume which is the object of addition, the command unit may treat the two or more pools as pools having the same reliability attribute.

In an eighth embodiment, the storage system may comprise a first pool and a second pool, and the command unit may preferentially cancel storage regions equivalent to the non-required capacity of the first pool and may allocate the storage regions to the logical volume which is the object of addition, and, if nevertheless the requested capacity is not satisfied and a capacity shortage occurs, then it may subtract, from the second pool, at least storage regions equivalent to the capacity shortage among the pool remaining capacity of the second pool, and add the storage regions to the first pool, and may allocate the added storage regions to the logical volume which is the object of addition.

In a ninth embodiment, in the above described eighth embodiment, when the requested capacity is not satisfied and a capacity shortage occurs even if the command unit subtracts, from the second pool, storage regions equivalent to the entire pool remaining capacity of the second pool and adds the storage regions to the first pool, then it may cancel the allocation of storage regions at least equivalent to the capacity shortage in the second pool, may subtract the canceled storage regions from the second pool and adds the storage regions to the first pool, and may allocate the added storage regions to the logical volume which is the object of addition.

In a tenth embodiment, in the above described first embodiment, the addition time point calculation unit may forecast, for the plurality of logical volumes, transitions of usage capacity accompanying the passage of time, and may calculate the addition time point based on a plurality of transitions which have been forecast for the plurality of logical volumes, respectively.

In an eleventh embodiment, the event may be a logical volume addition request from a manager, and a requested capacity may be included in the logical volume addition request.

In a twelfth embodiment, the management computer may further include a usage ratio calculation unit which calculates, for at least one of the plurality of logical volumes, a usage ratio which is the proportion of the usage capacity with respect to the allocated capacity. The event may mean that the calculated usage ratio has exceeded a predetermined usage ratio. And the decision unit may take the requested capacity as the difference between the required capacity which has been forecast and the allocated capacity.

In a thirteenth embodiment, the management computer may further include another decision unit which decides whether or not the accuracy of the required capacity which has been forecast is greater than or equal to a predetermined accuracy, an addition time point calculation unit which, if a negative decision result is obtained, calculates another time point in the future at which the requested capacity is to be satisfied as an addition time point, which is the time point at which the physical storage device is to be additionally provided, and an addition time point notification unit which notifies a manager of the calculated addition time point. And the certain time point may be the time point at which the physical storage device is to be additionally provided. Moreover, when calculating the non-required capacity, the non-required capacity calculation unit may use the required capacity of which the accuracy is greater than or equal to the predetermined accuracy, without using the required capacity of which the accuracy is less than the predetermined accuracy. Even further, the addition time point calculation unit may forecast, for the plurality of logical volumes, transitions of usage capacity accompanying the passage of time, and may calculate the addition time point based on a plurality of transitions which have been forecast for the plurality of logical volumes, respectively.

The various units described above may be expressed as means. These various units may be implemented in hardware (for example circuitry), by one or more computer programs, or by combinations of the above (for example, by one or a plurality of CPUs which read in an execute one or a plurality of computer programs). Each of these computer programs may be read in from a storage resource (for example a memory) which is provided to a computer device. They may also be installed into this storage resource via a recording medium such as a CD-ROM or a DVD (Digital Versatile Disk) or the like; or, alternatively, they may also be downloaded via a communication network such as the internet or a LAN or the like.

### BRIEF DESCRIPTION OF THE DRAWINGS

FIG. 1 is a schematic figure showing an example of the structure of a storage management system according to an embodiment of the present invention;

FIG. 2 is a figure showing an example of the structure of a storage management server 1010;

FIG. 3 is a figure showing an example of the structure of a storage system 1020;

FIG. 4 is an explanatory figure showing the relationship between a volume 3220 and a storage pool 3210;

FIG. 5 is a figure showing a structural example of a volume addition request 10000;

FIG. 6 is a figure showing an example of the structure of a computer management table 2210 which is maintained by the storage management server 1010;

FIG. 7 is a figure showing an example of the structure of a volume management table 2220 which is maintained by the storage management server 1010;

FIG. 8 is a figure showing an example of the structure of a usage capacity management table 2230 which is maintained by the storage management server 1010;

FIG. 9 is a figure showing an example of the structure of a usage capacity approximation table 2240 which is maintained by the storage management server 1010;

FIG. 10 is a figure showing an example of the structure of a pool management table 2250 which is maintained by the storage management server 1010;

FIG. 11 is a figure showing an example of the structure of a volume allocation management table 2260 which is maintained by the storage management server 1010;

FIG. 12 is a figure showing an example of the structure of a volume allocation change table 2280 which is maintained by the storage management server 1010;

FIG. 13 is a figure showing an example of the structure of a pool change table 2270 which is maintained by the storage management server 1010;

FIG. 14 is a figure showing an example of the structure of a volume management table 3120 which is maintained by the storage system 1020;

FIG. 15 is a figure showing an example of the structure of a pool management table 3110 which is maintained by the storage system 1020;

FIG. 16 is a figure showing an example of the structure of a storage region management table 3111 which is maintained by the storage system 1020;

FIG. 17 is a flow chart showing a summary of the processing of an information gathering program 2110 of the storage management server 1010;

FIG. 18 is a flow chart showing a summary of the processing of a volume management program 2120 of the storage management server 1010;

FIG. 19 is a flow chart showing a summary of the processing of a volume addition decision program 2130 of the storage management server 1010;

FIG. 20 is a flow chart showing a summary of the processing of the volume addition decision program 2130 for deciding whether requested capacity has been satisfied;

FIG. 21 is a flow chart showing a summary of the processing of a volume information updating program 2150 for updating volume information;

FIG. 22 is a flow chart showing a summary of the processing which is performed by an addition time point calculation program 2140 for performing calculation of an addition time point at which volume addition is possible; and

FIG. 23 is an explanatory figure showing a method for automatically determining requested capacity.

### DESCRIPTION OF THE PREFERRED EMBODIMENTS

In the following, embodiments of the present invention will be explained with reference to the drawings.

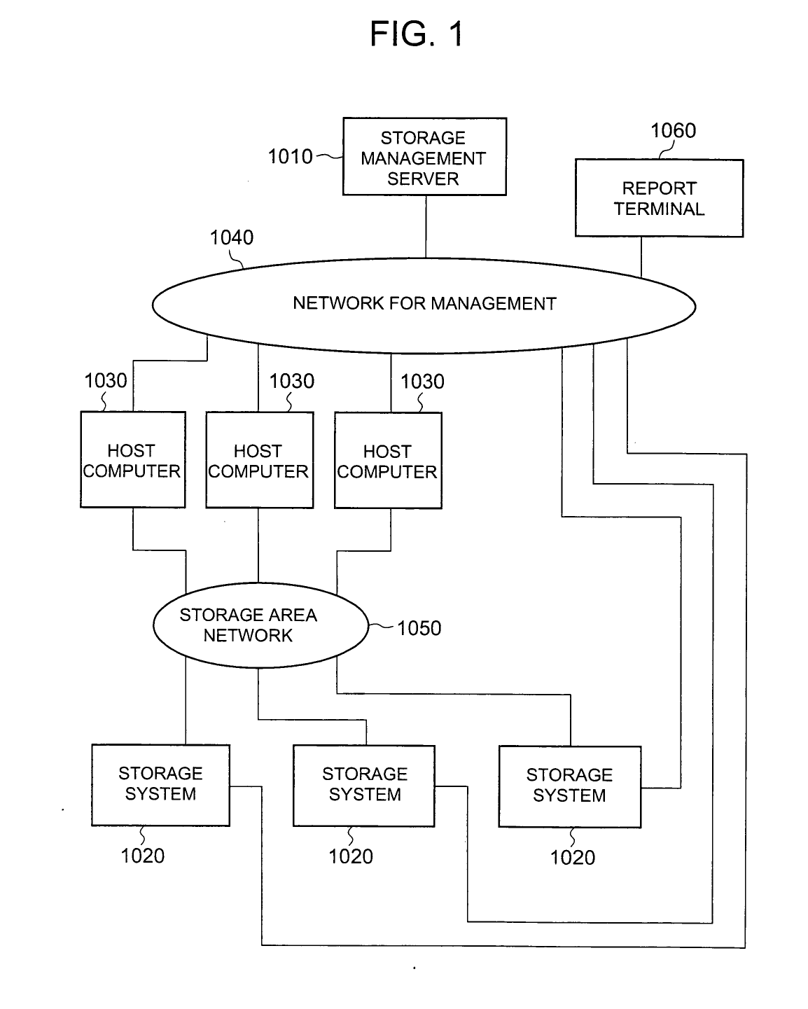

FIG. 1 is a schematic figure showing a structural example of a storage management system according to an embodiment of the present invention.

A storage management server 1010, a report terminal 1060, a plurality of host computers 1030, and a plurality of storage systems 1020 are connected to a network for management 1040 (there may be only one host computer 1030 and/or only one storage system 1020). Furthermore, the plurality of host computers 1030 and the plurality of storage systems 1020 are connected to a storage area network (SAN) 1050. Various types of network (for example a LAN (Local Area Network)) may be employed as the network for management 1040. Some other type of network may be employed, instead of the storage area network 1050. Furthermore, the network for management 1040 and the storage area network 1050 may be a single communication network.

Each of the host computers 1030, for example, may comprise a CPU, a memory, a port for management which is used for communication of data for management, and an I/O port which is used for communication with a storage system 1020. A usage capacity management table, which is an electronic table for managing the usage capacity of the volumes in use, is stored in the memory. In such a usage capacity management table, for example, there may be recorded, for each volume, a LUN which identifies this volume, and a volume usage capacity, which gives the usage capacity of this volume. When the host computer 1030 receives a usage capacity information request, it is able to transmit the information which is included in the usage capacity management table which is maintained within the host computer as usage capacity information to the originating source which transmitted the usage capacity information request. Furthermore, the host computer 1030 is able to issue I/O commands (write commands or read commands) for the volumes which are supplied from the storage system 1020, and thereby is able to write data into these volumes, and to read out data from them.

The storage system 1020, for example, may consist of a disk array device which comprises a plurality of physical storage devices (hereinafter termed physical disks) disposed in an array. A RAID (Redundant Array of Independent (or Inexpensive) Disks) group (also sometimes termed a parity group) may be made up of two or more physical disks among this plurality of physical disks. Supply of volumes to the host computer 1030, allocation of storage regions which are supplied by the physical disks to these volumes, cancellation of these storage region allocations, and allocation of these storage regions whose allocations have been cancelled to other volumes, can be performed by the storage system 1020 dynamically (in other words, while in the state of being on-line to the host computer 1030). The storage system 1020 is also able to store data from the host computer 1030 in the storage regions which have been allocated.

The storage management server 1010 is able to gather the usage capacity information for each volume from the host computers 1030. If a volume addition event has taken place, the storage management server 1010 is able, based on the usage capacity which it has gathered for each volume, to predict, for each volume, the volume capacity which may become necessary (in other words, which may be used) at a certain time point in the future (for example, at a time point which has been set in advance as a time point for additionally providing a physical disk). And, for each volume, the storage management server 1010 calculates the non-required capacity at the above described certain time point in the future from the volume capacity which has been predicted (hereinafter termed the required capacity) and the volume capacity which is currently allocated (hereinafter termed the allocated capacity), and is able, based on the one or more non-required capacities which have thus been calculated, to decide whether or not there is a storage region which can provide just the storage capacity which is requested (hereinafter termed the requested capacity) for the new volume which it is intended to add. Moreover, if a positive decision result is obtained, the storage management server 1010 is able to allocate the non-required capacity to the new volume. On the other hand, if a negative decision result is obtained, the storage management server 1010 calculates a physical disk addition time point for providing the requested capacity for the new volume, and is able to provide this physical disk addition time point which has thus been calculated.

The storage management server 1010 may display, on a display device not shown in the figure with which it is provided, the usage capacity information which has been gathered and/or the physical disk addition time point which has been calculated, and may also display them to a manager on the report terminal 1060 via the network for management 1040. This report terminal 1060 may also be provided integrally with the storage management server 1010.

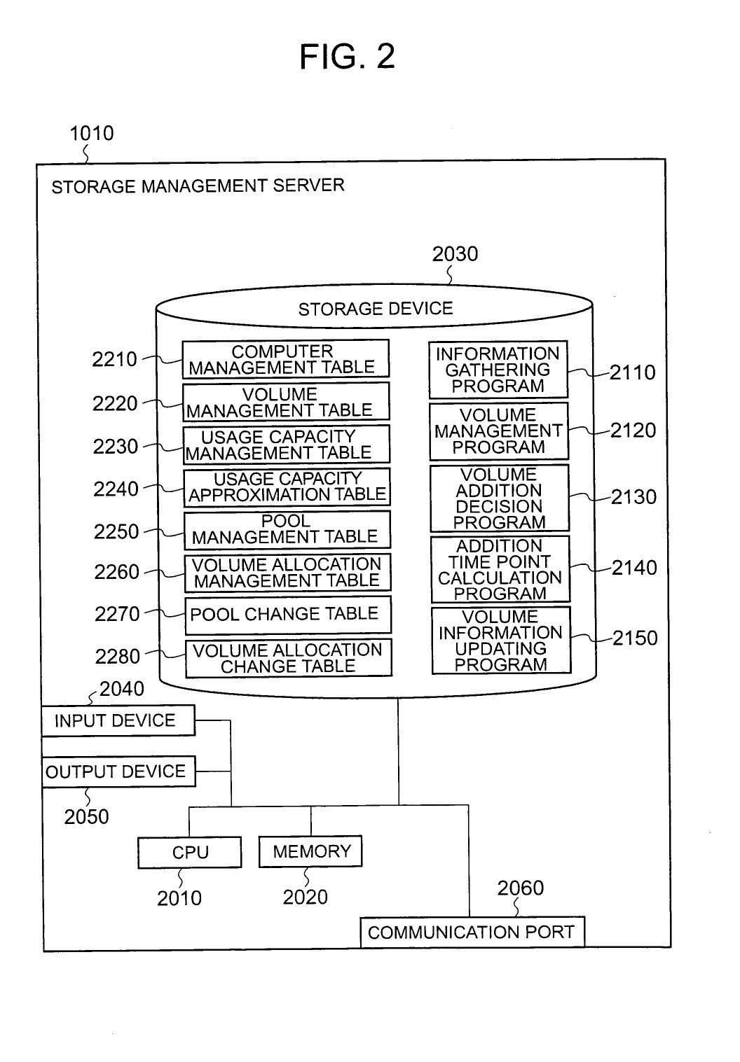

FIG. 2 is a figure showing an example of the structure of the storage management server 1010.

This storage management server 1010 is a type of computer. In concrete terms, the storage management server 1010 comprises a CPU 1020, a memory 2020, a storage device (for example, a hard disk drive) 2030, an input device (for example a keyboard and/or a mouse) 2040, an output device (for example a display device) 2050, and a communication port 2060. The storage management server 1010 can communicate data for management to the storage system 1020 and/or the host computers 1030 via its communication port 2060. A plurality of computer programs for causing the CPU 2010 to execute predetermined processes are stored in the storage device 2030. In this plurality of computer programs, for example, there are included an information gathering program 2110 for performing gathering of usage capacity information from the host computers 1030 and for gathering allocated host information from the storage system 1020, and a volume management program 2120 for performing volume management. Furthermore, for example, there may also be included a volume addition decision program 2130 for making a decision as to whether or not it is possible to add a new volume, an addition time point calculation program 2140 for performing calculation of an addition time point, and a volume information updating program 2150 for performing updating of volume information.

Furthermore, various types of information require for managing the host computers 1030 and/or the storage systems 1020 are storage in the storage device 2030. In concrete terms, for example, a plurality of electronic tables are stored therein. In this plurality of electronic tables, for example, there may be included a host computer management table 2210 in which is recorded information related to the host computers 1030 which use this storage system 1020, and a volume management table 2220 in which is recorded information related to the volumes which are the objects of usage capacity gathering. Furthermore, for example, there may also be included a usage capacity management table 2230 in which is recorded usage capacity information which has been gathered from the host computers 1030, a usage capacity approximation table 2240 in which is recorded information related to an approximate expression for volume usage capacities, and a pool management table 2250 in which is recorded information related to a storage pool. Moreover, for example, there may also be included a volume allocation management table 2260 in which is recorded information related to volume allocation, a pool change table 2270 in which is recorded information related to changes of the storage pool, and a volume allocation change table 2280 in which is recorded information related to changes of volume allocation.

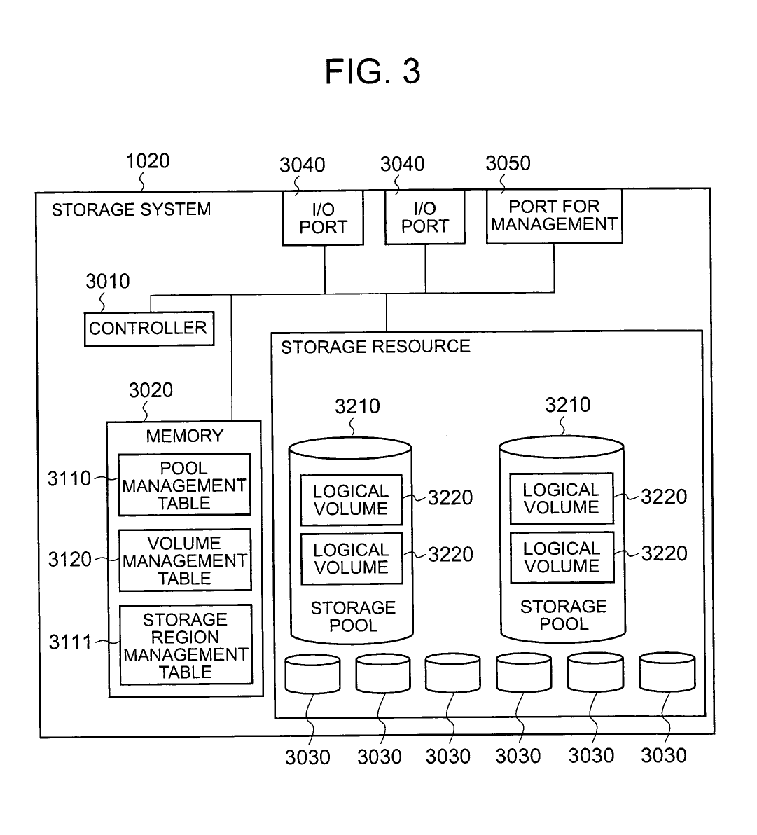

FIG. 3 is a figure showing an example of the structure of the storage system 1020.

This storage system 1020 comprises an I/O port 3040 which is an interface utilized in communication with the host computers 1030, a port for management 3050 which is an interface utilized for communication of data for management, a plurality of physical disks 3030, a controller (for example a CPU)3010 which performs control of the storage system 1020, and a memory 3020. The controller 3010 is able, when a write command has been received from a host computer 1030, temporarily to store data according to this write command in the memory 3020, and then to write this data which has been stored in the memory 3020 in a volume 3220 (more accurately, in a storage region which has been allocated to the volume 3220). On the other hand, the controller 3010 is also able, when a read command has been received from a host computer 1030, to read out data according to this read command from the appropriate volume 3220, temporarily to store this data which has been read out in the memory 3020, and then to transmit this data stored in the memory 3020 to the host computer 1030.

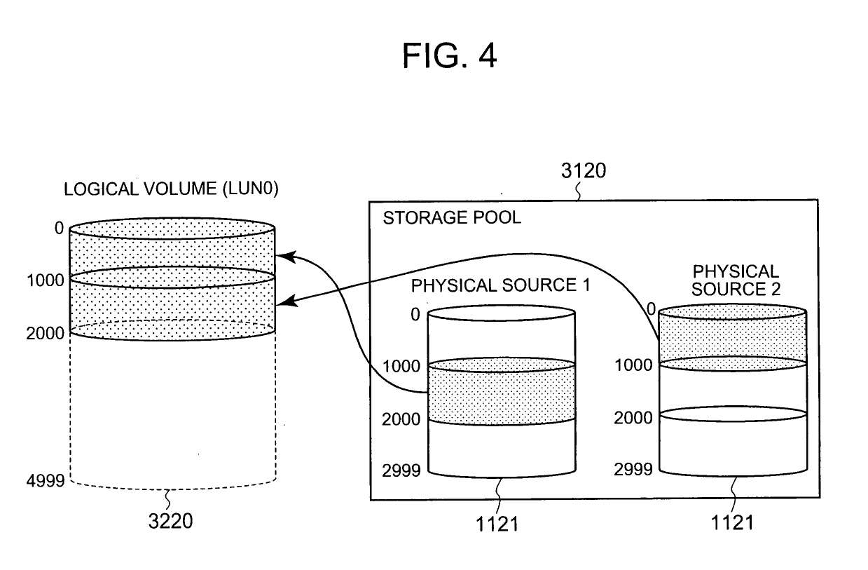

A plurality of storage pools 3210 (or one thereof) are provided to the storage system 1020. These storage pools 3210 are collections of a large number of storage regions which are supplied by the plurality of physical disks. In concrete terms, for example, as shown by way of example in FIG. 4, there are one or more physical resources (for example logical storage devices (LDEV)) 1121 which are supplied by the plurality of physical disks, and a storage pool may be constituted by a large number of storage regions on these one or more physical resources 1121. The controller 3010 is able to allocate the storage regions on each of the physical resources 1121 to volumes 3220, and to cancel such storage region allocations and return them to the storage pool 3210.

The memory 3020 can store computer programs which are executed by the controller 3010 and control information which is referred to by the controller 3010 and so on. As such control information, for example, there may be cited a plurality of electronic tables—in concrete terms, for example, a volume management table 3120 in which information related to the volumes is recorded, a pool management table 3110 in which information related to the storage pools 3210 is recorded, and a storage region management table 3111 in which information related to the storage regions is recorded.

The above is a summary of the storage management system according to the present invention. It should be understood that although, in this embodiment, the storage management server 1010 and the storage system 1020 are different devices, it would also be acceptable for programs which are executed by the storage management server 1010 to be stored in the storage resources of the storage system 1020 (for example in the memory 3020 or on a physical disk 3030).

In the following, the structural elements described above will be explained in detail.

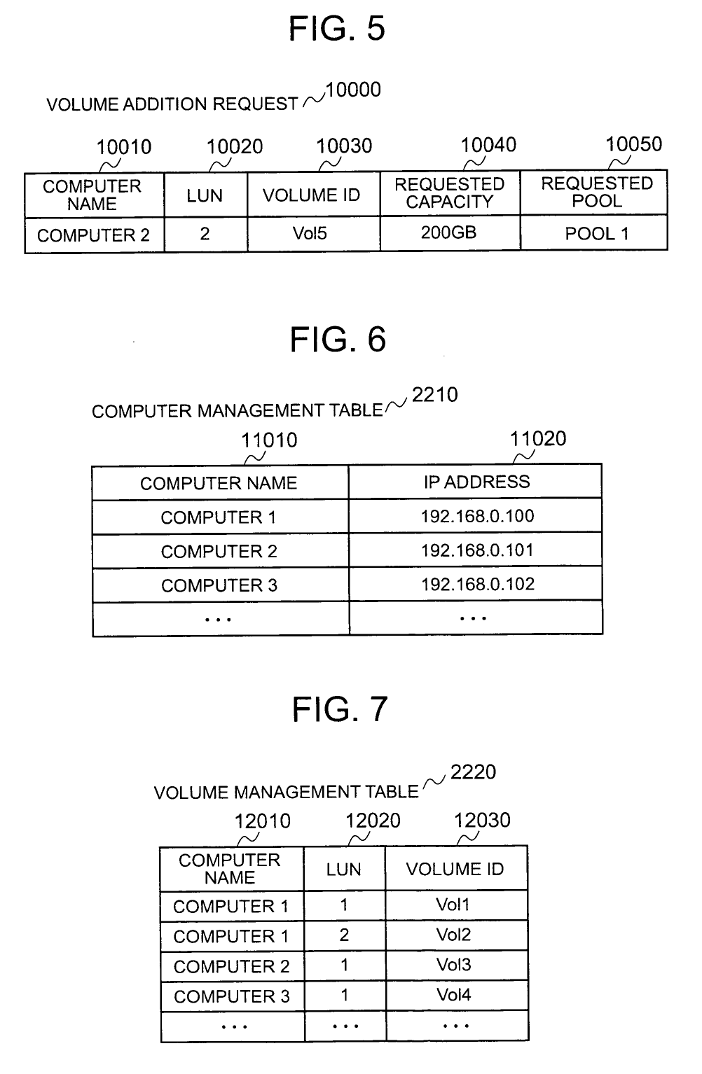

On receipt, as a volume addition event, of a volume addition request 10000 such as shown by way of example in FIG. 5, the storage management server 1010 may execute a volume addition decision program 2130. In this volume addition request 10000, for example, there may be included a computer name 10010, which is the computer name of the host computer 1030 which is to use the new volume which is to be added, and a LUN (Logical Unit Number) 10020, which is an ID for this host computer 1030 to identify the new volume. Furthermore, for example, there may also be included a volume ID 10030, which is an ID for the storage system 1020 to identify the new volume, a requested capacity 10040, which specifies the storage capacity which is requested for the new volume, and a request pool ID 10050, which is an ID for identifying the storage pool to which the new volume is to be allocated.

FIG. 6 is a figure showing an example of the structure of a computer management table 2210 which is maintained by the storage management server 1010.

In this computer management table 2210, there are recorded, for each host computer 1030, a host computer name 11010 which specifies a name for this host computer, and an IP address 11020, which specifies an IP address for this host computer.

FIG. 7 is a figure showing an example of the structure of a volume management table 2220 which is maintained by the storage management server 1010.

In this volume management table 2220, for each host computer, there are recorded the host computer name 12010, a LUN 12020 which is used by this host computer for identifying the volume, and a volume ID 12030, which is the ID of this volume. To express this in another manner, a record is maintained in this volume management table 2220 which shows which volumes are allocated for which host computers, and, as IDs for identifying which volumes these are, there are recorded LUNs which are IDs used by the host computers 1030, and volume IDs which are IDs used by the storage system 1020.

The host computer 1030 issues an I/O command which includes a LUN, and the storage system 1020 is able to specify the volume ID for this LUN, and, according to this I/O command, is able to perform writing in or reading out of data to or from the storage region allocated to the volume corresponding to the volume ID which has been specified.

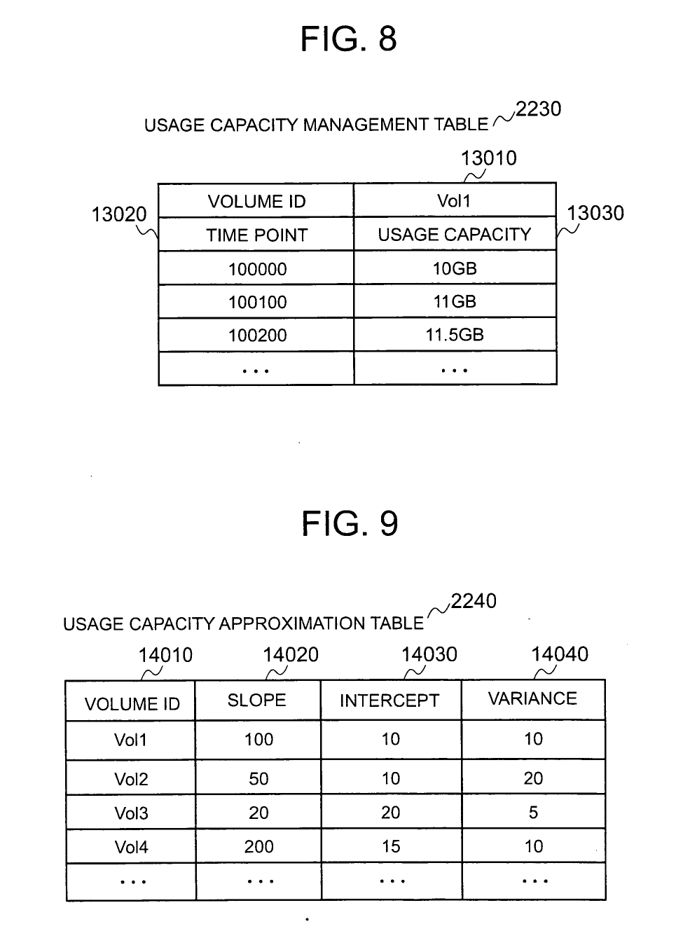

FIG. 8 is a figure showing an example of the structure of a usage capacity management table 2230 which is maintained by the storage management server 1010.

This usage capacity management table 2230 is a table which is created for each one of the volumes 3210. In this usage capacity management table 2230, for example, there is recorded the volume ID 13010 of the logical volume which constitutes the object of management by this usage capacity management table 2230; and, moreover, each time the gathering of usage capacity is performed, there is also recorded a set, which consists of a time point 13020 indicating the time point at which this gathering was performed, and a usage capacity 13030 which is information indicating the usage capacity that was gathered.

FIG. 9 is a figure showing an example of the structure of a usage capacity approximation table 2240 which is maintained by the storage management server 1010.

In this usage capacity approximation table 2240, for each of the volumes 3220, there are recorded a volume ID 14010, a slope 14020 in which is kept the slope of an approximate expression which linearly approximates the extension of usage capacity of this volume, a intercept 14030 in which is kept a intercept of this approximate equation which linearly approximates the extension of usage capacity of this volume, and a variance 14040 in which is kept the variance of this approximate expression which linearly approximates the extension of the volume usage capacity of this volume.

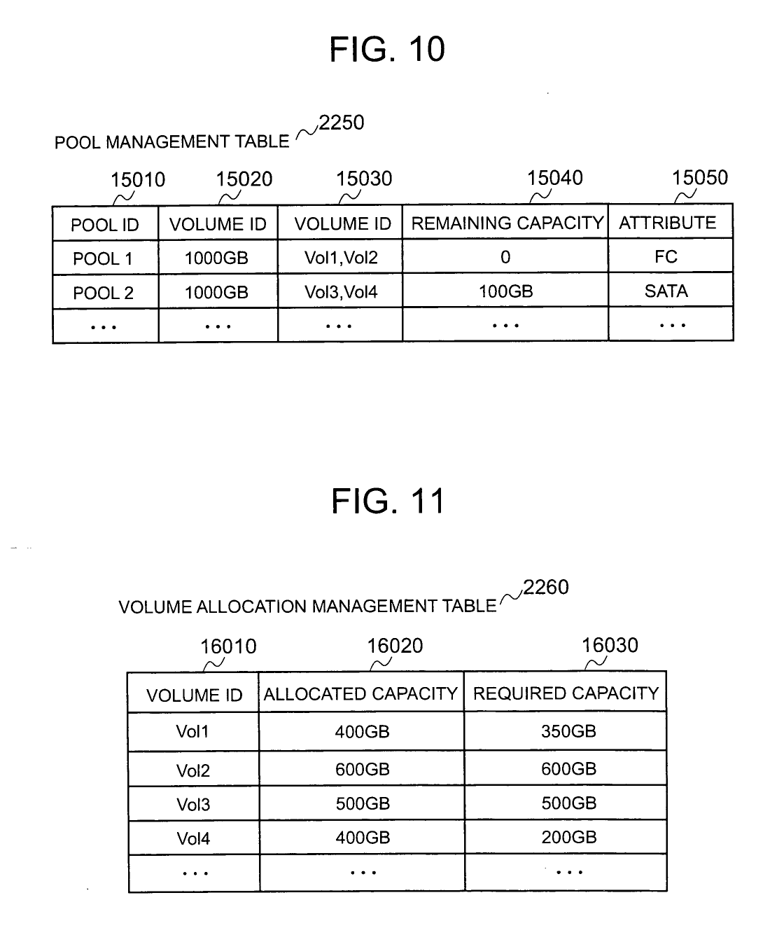

FIG. 10 is a figure showing an example of the structure of a pool management table 2250 which is maintained by the storage management server 1010.

In the pool management table 2250, for each of the storage pools 3210, there are recorded a pool ID 15010 which is for identifying this storage pool 3210, a pool capacity 15020 which indicates the capacity of this storage pool 3210, a volume ID 15030 for identifying the volume 3220 which is associated with this storage pool 3210, a remaining capacity 15040 which indicates the unused storage capacity of this storage pool 3210, and an attribute 15050 which is information which indicates attributes of this storage pool 3210. If a plurality of volumes 3220 related to this storage pool 3210 are present, then the volume IDs 15030 may be inputted delimited by commas. The attributes of the storage pool 3210, in concrete terms, are attributes related to reliability, and in more concrete terms, for example, are attributes of the physical disks which make up this pool. As such attributes, there may be employed the types of the physical disks (for example fiber channel (FC) or serial ATA (SATA) or the like), and the RAID level of the RAID group of which this physical disk is a structural element and the like.

FIG. 11 is a figure showing an example of the structure of a volume allocation management table 2260 which is maintained by the storage management server 1010.

In this volume allocation management table 2260, for each of the volumes 3220, there are recorded the volume ID 16010, an allocated capacity 1602 which indicates the capacity which is allocated to this volume, and a required capacity 16030 which indicates the capacity that this volume will require at a certain time point in the future.

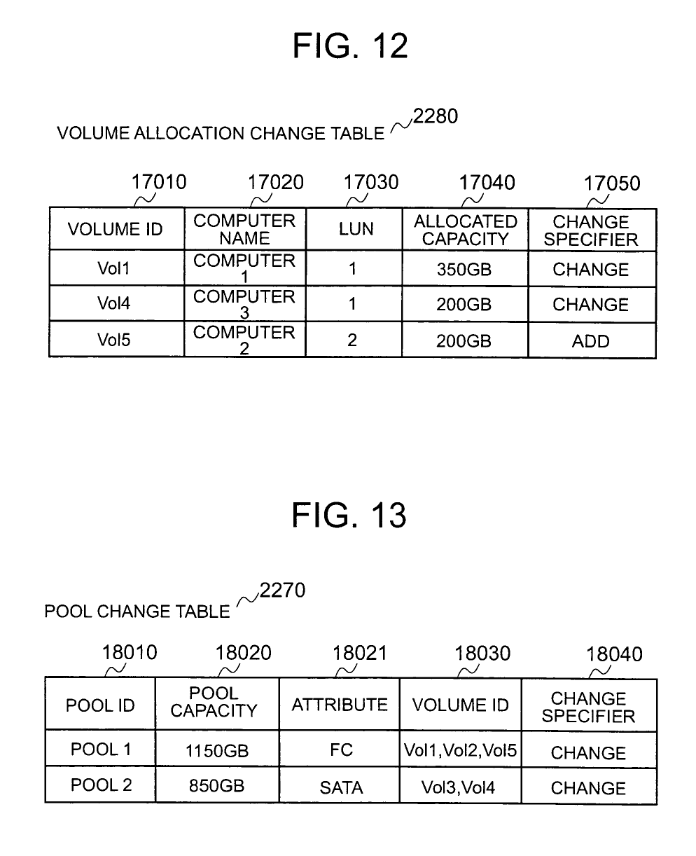

FIG. 12 is a figure showing an example of the structure of a volume allocation change table 2280 which is maintained by the storage management server 1010.

In this volume allocation change table 2280, for each of the volumes 3220, there are recorded the volume ID 17010, the host computer name 17020 of the host computer to which this volume is supplied, a LUN 17030 for identification of this volume by this host computer, the allocation capacity 17040 of this volume, and a change specifier 17050. As the specification which may be recorded for the change specifier 17050, for example, there may be “changed” which shows that at least a portion of the records in this table 2280 (for example at least one of the volume ID, the computer name, the LUN, and the allocated capacity) has changed, “added” which shows that a new record has been added, and “deleted” which shows that a record has been deleted.

FIG. 13 is a figure showing an example of the structure of a pool change table 2270 which is maintained by the storage management server 1010.

In this pool change table 2270, there are recorded, for each of the storage pools 3210, a pool ID 18010, a pool capacity 18020, an attribute 18021, a volume ID 18030, and a change specifier 18040. As the specification which may be recorded for the change specifier 18040, for example, there may be “changed” which shows that at least a portion of the records in this table 2270 (for example at least one of the pool ID, the pool capacity, the attribute, and the volume ID) has changed, “added” which shows that a new record has been added, and “deleted” which shows that a record has been deleted.

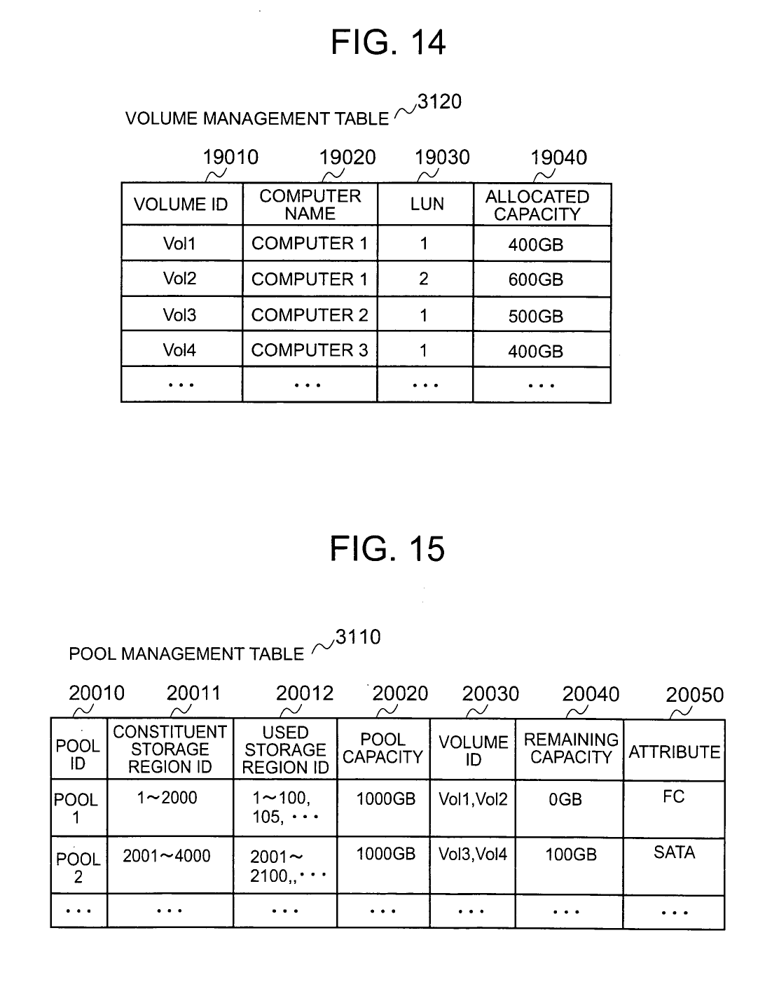

FIG. 14 is a figure showing an example of the structure of a volume management table 3120 which is maintained by the storage system 1020.

In this volume management table 3120, for each of the volumes 3220, there are recorded a volume ID 19010, a host computer name 19020 which indicates the host computer to which this volume is supplied, a LUN 19030 which is used by this host computer for identifying this volume, and the capacity 19040 which is allocated to this volume.

When the storage system 1020 receives a volume information request via the port for management 3050, it transmits information which is included in the volume management table 3120 which is maintained within the memory 3020 as volume information to the origin which transmitted the volume information request.

Furthermore, the storage system 1020 receives pool information settings notification via the port for management 3050. In this notification of pool information settings, there are included the pool ID, the pool capacity, the volume ID, and a change specifier. This change specifier may, for example, be a value which assumes any one of the values “add”, “change”, and “delete”. When the storage system 1020 receives a pool information settings notification via the port for management 3050, it is able to perform the following processes, according to the value of the change specifier. For example, if the change specifier is “add”, then the storage system 1020 adds the information which is included in the pool information settings notification to the pool management table 3110 as a new record. Or, if the change specifier is “change”, then, among the information which is included in the pool management table 3110, the storage system 1020 overwrites the record with the same pool ID as the pool ID 20010 which is included in the pool information settings notification, with the information which is included in the pool information settings notification. And, if the change specifier is “delete”, then, among the information which is included in the pool management table 3110, the storage system 1020 deletes the record with the same pool ID as the pool ID 20010 which is included in the pool information settings notification.

Furthermore, the storage system 1020 receives volume information settings notification via the port for management 3050. In this volume information settings notification, for example, there may be included a volume ID, a host computer name, a LUN, an allocated capacity, and a change specifier. This change specifier may, for example, be a value which assumes any one of the values “add”, “change”, and “delete”. When the storage system 1020 receives a pool information settings notification via the port for management 3050, it is able to perform the following processes, according to the value of the change specifier. For example, if the change specifier is “add”, then the storage system 1020 adds the information which is included in the volume information settings notification to the volume management table 3120 as a new record. Or, if the change specifier is “change”, then, among the information which is included in the volume management table 3120, the storage system 1020 overwrites the record with the same volume ID as the volume ID 19010 which is included in the volume information settings notification, with the information which is included in the volume information settings notification. And, if the change specifier is “delete”, then, among the information which is included in the volume management table 3120, the storage system 1020 deletes the record with the same volume ID as the volume ID 19010 which is included in the volume information settings notification.

FIG. 15 is a figure showing an example of the structure of a pool management table 3110 which is maintained by the storage system 1020.

In this pool management table 3110, there are recorded, for each of the storage pools 3210, the pool ID 20010, a constituent storage region ID 20011 which specifies all of the storage regions which make up this storage pool, used storage region IDs 20012 which specify the storage regions, among those storage regions, which have been allocated to volumes, the pool capacity 20020, the volume IDs 20030 of the volumes which belong to this storage pool, the remaining capacity 20040, and an attribute 20050.

When the storage system 1020 receives a pool information request via the port for management 3050, it transmits the information which is included in the pool management table 3110 which is maintained in the memory 3020 as pool information to the origin which transmitted the pool information request.

Furthermore, the storage system 1020 receives pool information settings notification via the port for management 3050. In this notification of pool information settings, there are included the pool ID, the pool capacity, the volume ID, and a change specifier. This change specifier may, for example, be a value which assumes any one of the values “add”, “change”, and “delete”. When the storage system 1020 receives a pool information settings notification via the port for management 3050, it is able to perform the following processes, according to the value of the change specifier. For example, if the change specifier is “add”, then the storage system 1020 adds the information which is included in the pool information settings notification to the pool management table 3110 as a new record. Or, if the change specifier is “change”, then, among the information which is included in the pool management table 3110, the storage system 1020 overwrites the record with the same pool ID as the pool ID 20010 which is included in the pool information settings notification, with the information which is included in the pool information settings notification. And, if the change specifier is “delete”, then, among the information which is included in the pool management table 3110, the storage system 1020 deletes the record with the same pool ID as the pool ID 20010 which is included in the pool information settings notification.

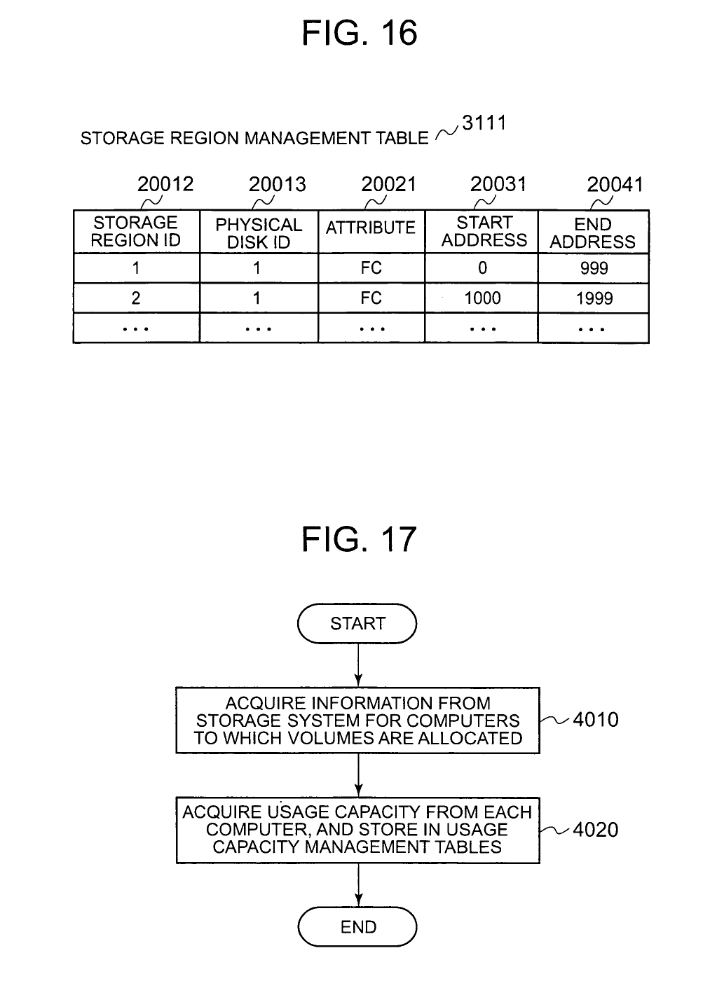

FIG. 16 is a figure showing an example of the structure of a storage region management table 3111 which is maintained by the storage system 1020.

In this storage management table 3111, for each of the storage regions, there are recorded a storage region ID 20012 for identifying this storage region, a physical disk ID for identifying the physical disk which contains this storage region, an attribute 20021 of this physical disk, the start address 20031 of this storage region on the physical resource, and the final address 20041 of this storage region on this physical resource.

In this storage system 1020, the storage pools 3210 may be made up of storage regions on physical disks which have the same attribute as its attribute. When allocating a storage region to a volume 3220, the controller 3010 may allocate an unused storage region from the storage pool 3210 which is related to this volume 3220. At this time, the controller 3010 may note the ID of this storage region which has been allocated in the entry for the usage storage region ID 20012 which corresponds to this storage pool 3210, and may reduce the remaining capacity which is recorded in the margin of the remaining capacity 20040, and may reduce the remaining capacity which is recorded in the entry for the remaining capacity 20040 by the capacity of the storage region which has been allocated. Furthermore, when a storage region allocation has been deleted from the volume 3220, the controller 3010 may delete the ID of this storage region from the entry for the used storage region IDs 20012, and may increase the remaining capacity which is recorded in the entry for the remaining capacity 20040 by the capacity of the storage region whose allocation has been deleted.

The flow of processing performed in this embodiment will now be described below.

First, a summary of the information gathering which is performed by the storage management server 1010 will be explained.

FIG. 17 is a flow chart showing a summary of the processing of an information gathering program 2110 of the storage management server 1010.

Initially (in a step 4010), this information gathering program 2110 transmits a volume information request to the storage system 1020 and receives volume information as a response, and, based on this volume information which has been received, updates the host computer management table 2210, the volume management table 2220, and the usage capacity management tables 2230. In concrete terms, for example, the information gathering program 2110 stores the host computer name which is included in the volume information which has been received in the host computer name 11010 of the host computer management table 2210, and the IP address which has been received in the IP address 11020 of the host computer management table 2210. Furthermore, it stores the host computer name which is included in the volume information in the host computer name 12010 of the volume management table 2220, the LUN which is included in the volume information in the LUN 12020 of the volume management table 2220, and the volume ID which is included in the volume information in the volume ID 12030 of the volume management table 2220. Moreover, it creates a usage capacity management table 2230 for each volume ID included in the volume information.

Next, the information gathering program 2210 transmits a usage capacity information requests to the host computers 1030 which are listed in the host computer management table 2210, and receives usage capacity information as responses. And (in a step 4020) the information gathering program 2110 stores the time point at which this information was gathered in the time point entry 13020 of the usage capacity management table 2230 for the volume ID included in the usage capacity information which was received from each of the host computers 1030, and the usage capacity in its usage capacity entry 13030.

Next a summary of the addition of a new volume, which is performed by the storage management server 1010, will be explained.

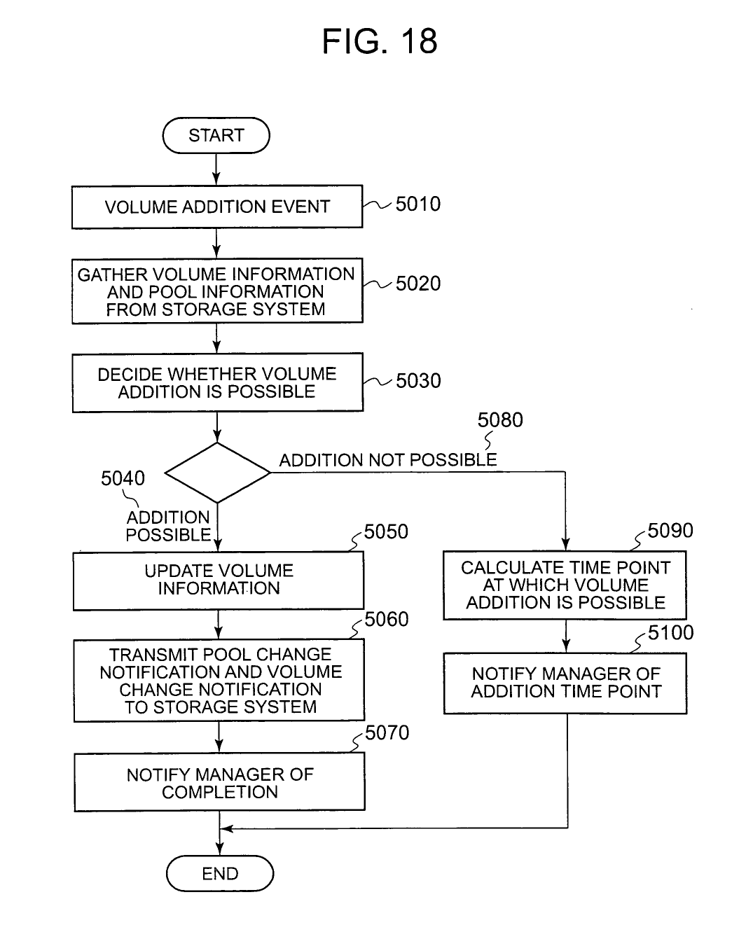

FIG. 18 is a flow chart showing a summary of the processing of a volume management program 2120 of the storage management server 1010.

First, if a volume addition event has occurred (in a step 5010), this volume management program 2120 of the storage management server 1010 gathers the volume information and the pool information from the storage system 1020 (in a step 5020). In the step 5010, for example, via the input device 2040, the volume management program 2120 may receive the volume addition request 10000 which was shown by way of example in FIG. 5, and the addition time point information, which is the next time point for a physical disk to be added. And, in the step 5020, the volume management program 2120 performs, for example, the processing described below.

First, the volume management program 2120 transmits a volume information request to the storage system 1020, and receives volume information as a response. And the volume management program 2120 stores the volume ID of the volume information in the volume ID 16010 of the volume allocation management table 2260, and the allocated capacity of the volume information in the allocated capacity 16020 of the volume allocation management table 2260.

Next, the volume management program 2120 transmits a pool information request to the storage system 1020, and receives pool information as a response thereto. And the volume management program 2120 stores the pool ID of the pool information in the pool ID 15010 of the pool management table 2250, the pool capacity of the pool information in the pool capacity 15020 of the pool management table 2250, the volume ID of the pool information in the volume ID 15030 of the pool management table 2250, and the remaining capacity of the pool information in the remaining capacity 15040 of the pool management table 2250.

The above described processing completes the step 5020.

Next (in a step 5030), the volume management program 2120 decides, using a volume addition decision program 2130, whether or not it is possible to add the volume which has been requested.

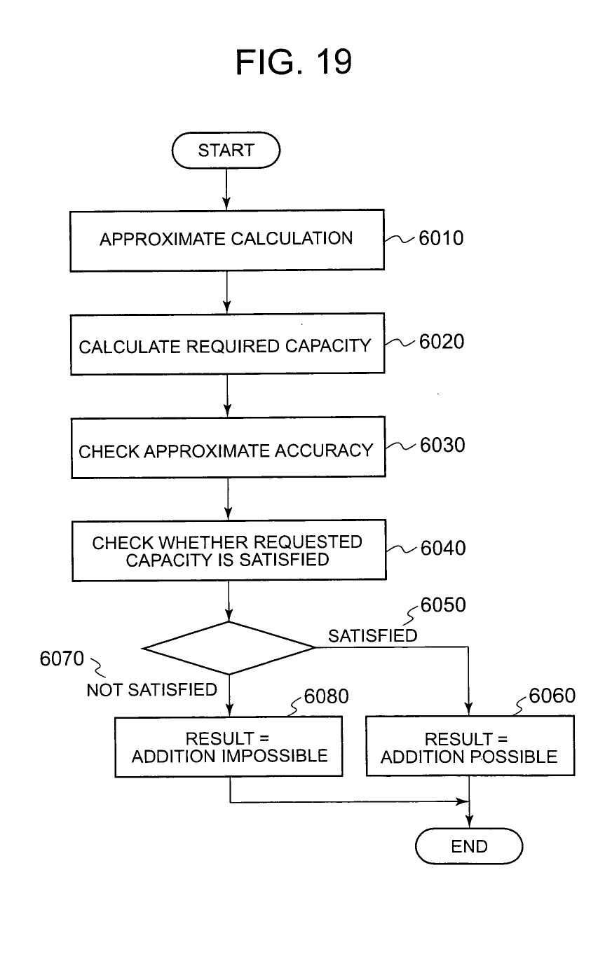

FIG. 19 is a flow chart showing a summary of the processing of this volume addition decision program 2130 of the storage management server 1010.

First (in a step 6010), the volume addition decision program 2130 performs an approximate calculation of the extension of the usage capacity for each volume, using the usage capacity information which has been stored in the usage capacity management table 2230, and stores the result in the usage capacity approximation table 2240. In this embodiment, this extension of the volume usage capacity is approximated by a linear approximation by, for example, the method of least squares; but other methods of approximation might be used.

Next (in a step 6020), the volume addition decision program 2130 calculates, using a volume usage capacity approximate expression, the required capacity at a physical disk addition time point which has been received from a manager (in other words, forecasts the volume capacity which will likely be required at the time point of this physical disk addition time point), and stores this required capacity which has thus been calculated in the required capacity item 16030 of the volume allocation management table 2260.

Next (in a step 6030), the volume addition decision program 2130 checks the accuracy of the approximate expression which gave the extension of volume usage capacity. In concrete terms, for example, for a volume for which the value of the variance 14040 in the usage capacity management table 2230 is larger than a threshold value for variance which is set in advance, the volume addition decision program 2130 may decide that the accuracy of the approximate expression for this volume is low, and may delete it from the volume allocation management table 2260. In other words, in the subsequent processing, the program may not take the required capacity of a volume for which the accuracy of the approximate expression is low (i.e. for which the accuracy of the required capacity is low) as an object of comparison with the requested capacity.

Next (in a step 6040) the volume addition decision program 2130 decides whether or not the requested capacity is satisfied.

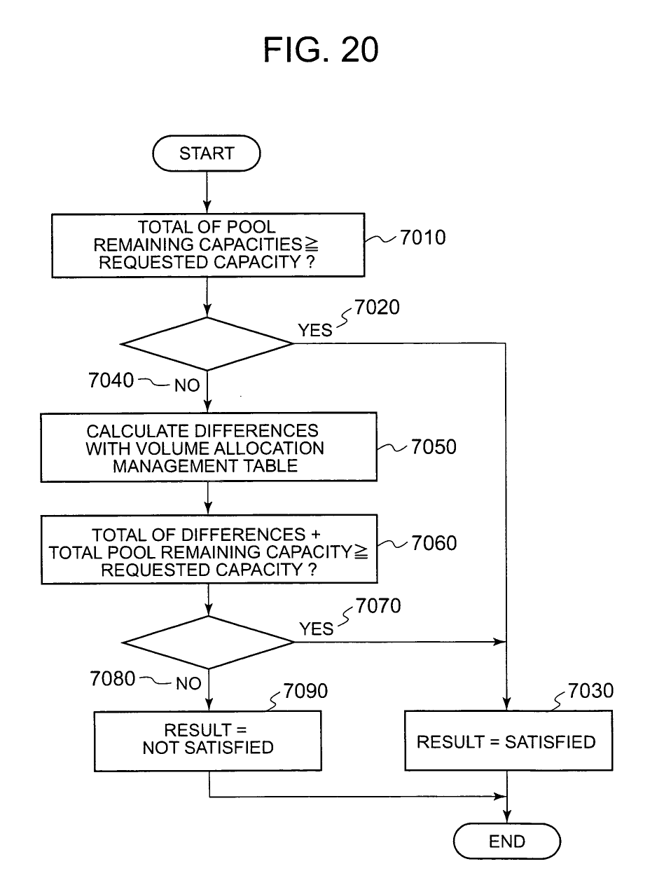

FIG. 20 is a flow chart showing a summary of the flow of processing by which the volume addition decision program 2130 decides whether or not the requested capacity is satisfied.

First (in a step 7010), the volume addition decision program 2130 decides whether or not the total of the remaining capacity values 15040 of the pools included in the pool management table 2250 is greater than or equal to the requested capacity for the new volume.

If (in a step 7020) it has been decided that the total of these remaining capacity values 15040 is greater than or equal to the requested capacity for the new volume, then (in a step 7030) the volume addition decision program 2130 decides that the requested capacity is satisfied.

On the other hand, if (in a step 7040) it has been decided that the total of these remaining capacity values 15040 is less than the requested capacity for the new volume, then (in a step 7050) the volume addition decision program 2130 calculates, for each volume, the difference between the allocated capacity 16020 in the volume allocation management table 2260 and the required capacity 16030, and calculates the total value of these differences for all of the volumes.

Next (in a step 7060), the volume addition decision program 2130 decides whether or not the sum of the total values of the differences and the total value of pool remaining capacity is greater than or equal to the requested capacity for the new volume.

If (in a step 7070) it has been decided that the sum of the total values of the differences and the total value of pool remaining capacity is greater than or equal to the requested capacity for the new volume, then the volume addition decision program 2130 decides (in a step 7030) that the requested capacity is satisfied.

On the other hand if (in a step 7080) it has been decided that the sum of the total values of the differences and the total value of pool remaining capacity is smaller than the requested capacity for the new volume, then the volume addition decision program 2130 decides (in a step 7090) that the requested capacity is not satisfied.

FIG. 19 will now be again referred to. If the requested capacity is satisfied (in the step 6050), then the volume addition decision program 2130 decides that it is possible to add the new volume (in the step 6060); while, if the requested capacity is not satisfied (in the step 6070), then the volume addition decision program 2130 decides that it is possible to add the new volume (in the step 6080).

The above is an explanation of a summary of the processing performed by the volume addition decision program 2130 of the storage management server 1010.

FIG. 18 will now be again referred to. If it is possible to add the new volume (in the step 5040), then the volume management program 2120 updates the volume information (in a step 5050) using the volume information updating program 2150.

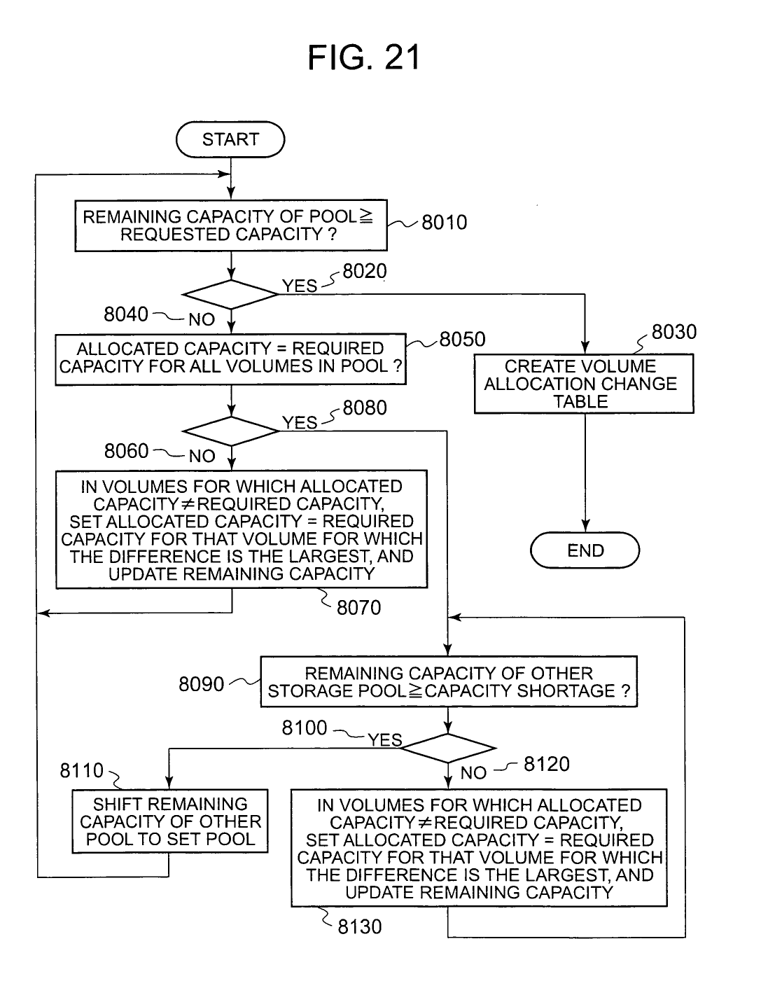

FIG. 21 is a flow chart showing a summary of the flow of processing by which the volume information updating program 2150 performs updating of the volume information.

First (in a step 8010), this volume information updating program 2150 decides whether or not it is possible to allocate the new volume within the storage pool which has been set by the volume addition request 10000.

If (at the branch 8020) it has been decided that the remaining capacity in the storage pool which was set in the volume addition request 10000 is greater than or equal to the requested capacity, then (in a step 8030) the volume information updating program 2150 creates (or updates) the volume allocation change table. In concrete terms, for example, the volume information updating program 2150: stores the request pool ID 10050 which has been set in the volume addition request 10000 in the pool ID 18010 of the pool change table 2270; stores the pool capacity 15020 of the pool management table 2250 in the pool capacity 18020 of the pool change table 2270; stores a value in the volume ID 18030 of the pool change table 2270 which has been increased by adding in the volume ID 10030 which was set in the value of the volume ID 15030 of the pool management table 2250 by the volume addition request 10000, comma delimited; and stores the fact that the value has been changed in the change specifier 18040 of the pool change table 2270. Furthermore, the volume information updating program 2150: stores the volume ID 10030 which was set by the volume addition request 10000 in the volume ID 17010 of the volume allocation change table 2280; stores the host computer name 10010 which was set by the volume addition request 10000 in the host computer name 17020 of the volume allocation change table 2280; stores the LUN 10020 which was set by the volume addition request 10000 in the LUN 17030 of the volume allocation change table 2280; stores the requested capacity 10040 which was set by the volume addition request 10000 in the allocated capacity 17040 of the volume allocation change table 2280; and stores the fact that the value has been added in the change specifier 17050 of the volume allocation change table 2280.

On the other hand, if it has been decided (at the branch 8040) that the remaining capacity of the storage pool which was set by the volume addition request 10000 is smaller than the requested capacity, then the volume information updating program 2150 decides (in a step 8050) whether or not, for all of the volumes which belong to the pool which has been set, the allocated capacity 16020 and the required capacity 16030 are equal.

If (at the branch 8060) the result is that a volume is present for which the allocated capacity 16020 and the required capacity 16030 are not equal, then the volume information updating program 2150 performs a step 8070. In concrete terms, for example, the volume information updating program 2150 overwrites the value of the remaining capacity 15040 in the pool management table 2250 with a value to which has been added the difference between the allocated capacity 16020 and the required capacity 16030. Furthermore, in the volume allocation management table 2260, the volume information updating program 2150 overwrites the allocated capacity of that volume for which the difference is the largest with the value of the required capacity. Yet further, the volume information updating program 2150 inputs the volume ID of the volume which has been overwritten and stores it in the volume ID 17010 of the volume allocation change table 2280, inputs the capacity which has been overwritten and stores it in the allocated capacity 17040 of the volume allocation change table 2280, and stores an indication of the fact that a change has occurred in the change specifier 17050 of the volume allocation change table 2280; and then the flow of control returns to the step 8010.

If (at the branch 8080) the allocated capacity 16020 of all the volumes in the set pool and the required capacity 16030 are equal (in the step 8050), then the volume information updating program 2150 decides (in a step 8090) whether or not the remaining capacity in another storage pool is greater than or equal to the capacity shortage which is obtained by subtracting the remaining capacity of the pool which has been set from the requested capacity which was set in the volume addition request 10000.

If the remaining capacity of some other pool is greater than or equal to the capacity shortage (at the branch 8100), then the volume information updating program 2150 performs a step 8110. In concrete terms, for example, the volume information updating program 2150 overwrites the value of the remaining capacity 15040 of the other pool in the pool management table 2250 with a value which is obtained by subtracting the capacity shortage therefrom, and overwrites the pool capacity of the other pool with a value which is obtained by subtracting the capacity shortage therefrom. Moreover, the volume information updating program 2150 overwrites the remaining capacity 15040 of the pool which has been set with a value which is obtained by adding the capacity shortage thereto, and overwrites the pool capacity of the pool which has been set with a value which is obtained by adding the capacity shortage thereto. Yet further, the volume information updating program 2150: inputs the pool ID of the other pool and stores it in the pool ID 18010 of the pool change table 2270; inputs the pool capacity of the other pool and stores it in the pool capacity 18020 of the pool change table 2270; inputs the value of the pool ID 15010 of the pool management table 2250 and stores it in the volume ID 18030 of the pool change table 2270; and stores an indication of the fact that a change has occurred in the change specifier 18040 of the pool change table 2270; and then the flow of control returns to the step 8010.

If, in the step 8090, it has been decided (at the branch 8120) that the remaining capacity of the other pool is smaller than the capacity shortage, then the volume information updating program 2150 performs a step 8130. In concrete terms, for example, the volume information updating program 2150 overwrites the value of the remaining capacity 15040 of the other pool in the pool management table 2250 with the value obtained by adding the difference between the allocated capacity 16020 and the required capacity 16030. Furthermore, the volume information updating program 2150 overwrites the allocated capacity of that volume for which the difference is largest with the value of the required capacity, in the volume allocation management table 2260. Yet further, the volume information updating program 2150 inputs the volume ID of the volume which has been overwritten and stores it in the volume ID 17010 of the volume allocation change table 2280, inputs the capacity which has been overwritten and stores it in the allocated capacity 17040 of the volume allocation change table 2280, and stores an indication of the fact that a change has occurred in the change specifier 17050 of the volume allocation change table 2280; and then the flow of control returns to the step 8090.

The above completes the explanation of the processing which is performed by the volume information updating program 2150.

Reference will now be made to FIG. 18. The volume management program 2120 transmits (in a step 5060) to the storage system 1020 information which is included in the pool change table 2270 as a pool change notification, and furthermore transmits thereto information which is included in the volume allocation change table 2280 as a volume change notification. And, based on this volume change notification, the storage system 1020, for example, in the pool management table 3110, may reduce the capacity of the other pool and, along therewith, may reduce the constituent storage region ID, and may add the amount of this reduction to the capacity of the set pool or to the constituent storage region ID.

Next, the volume management program 2120 outputs (in a step 5070) a completion notification to the manager via the output device 2050.

If, in the step 5030, it is not possible to add the new volume (at the branch 5080), then the volume management program 2120 calculates (in a step 5090) the addition time point at which volume addition will be possible, using the addition time point calculation program 2140.

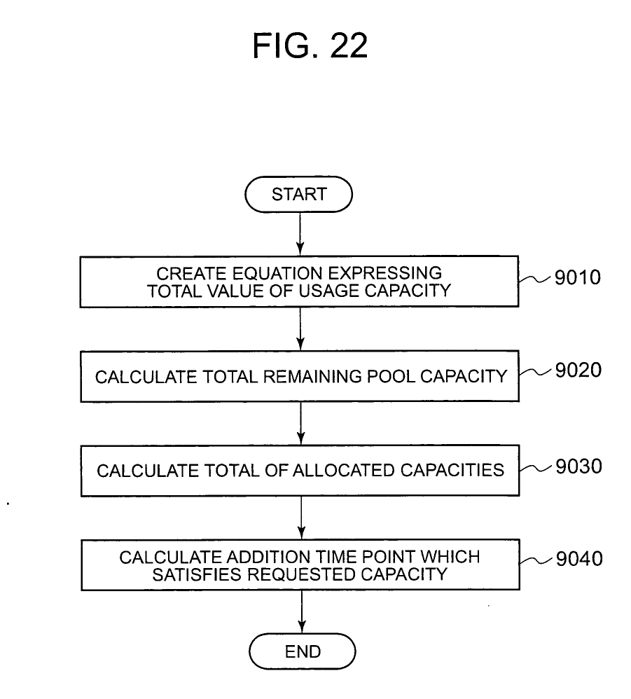

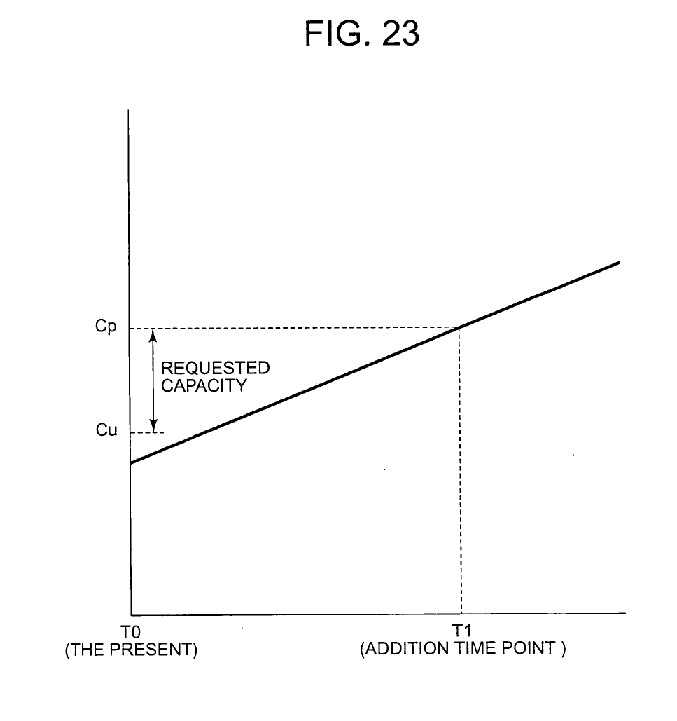

FIG. 22 is a flow chart showing a summary of the processing by which this addition time point calculation program 2140 performs calculation of the addition time point at which volume addition will be possible.

First, this addition time point calculation program 2140 creates (in a step 9010) an equation which completely sums up the approximate expression information included in the usage capacity approximation table 2240—for example, (total required capacity)=(total of slopes 14020) □ (addition time point)+(total of intercepts 14030).

Next, the addition time point calculation program 2140 totals the remaining capacities 15040 of the records included in the pool management table 2250, and calculates (in a step 9020) a total remaining pool capacity.

Next, the addition time point calculation program 2140 totals the allocated capacities 16020 of the records included in the volume allocation management table 2260, and calculates (in a step 9030) a total allocated capacity.

Next, the addition time point calculation program 2140 calculates (in a step 9040) an addition time point which satisfies the requested capacity. This addition time point which satisfies the requested capacity may be, for example, the time point at which the following equation:

requested capacity=(total remaining pool capacity)+(total of allocated capacities) (total of required capacities)

is satisfied. The equation below is a variant of this equation:

addition time point={(total remaining pool capacity)+(total of allocated capacities) (requested capacity) (total of intercepts 14030)}÷(total of slopes 14020)

The above completes the explanation of the processing which is performed by the addition time point calculation program 2140.

When this processing is completed, as shown in FIG. 18, (in a step 5100), the volume management program 2120 outputs the calculated addition time point to the manager via the output device 2050.

The above completes the explanation of the processing which is performed by the volume management program 2120 of the storage management server 1010.

As described above, according to the above described embodiment, if a volume addition event has occurred, based on the usage capacity which has been gathered for each volume, the storage management server 1010 forecasts, for each volume, the volume capacity (in other words, the required capacity) which will likely become necessary at a certain time point in the future, calculates the non-required capacities from the required capacities which have thus been forecast and the allocated capacities, and decides, based on one or more non-required capacity which has been calculated, whether or not there is a storage region enough to satisfy the requested capacity of the new volume; and, if the result of this decision is positive, is able to allocate a storage region equivalent to the non-required capacity to the new volume. By doing this it is possible to optimize the allocation of storage regions, so as to suppress, as much as possible, storage regions being uselessly allocated to volumes for the host computers.

Furthermore, according to the above described embodiment, a certain time point in the future is taken as being the physical disk addition time point. If a physical disk is additionally provided, it is possible to increase the number of storage regions which can be allocated to volumes to a corresponding extent. Accordingly, it is considered that performing storage region allocation based on the forecast value at (the required capacity) at that time point is suitable for suppression of useless allocation of storage regions. In concrete terms, for example, when storage region allocation is performed based on a forecast value at a time point which is further in the future than the physical disk addition time point, if the required at that farther time point is larger, then, irrespective of whether previous to that time point a physical disk is additionally provided and the number of storage regions is increased, a larger number of storage regions come to be allocated than in the case in which allocation is performed based on a forecast value at the addition time point, which is undesirable. If this is done the efficiency becomes low, since the number of storage regions which are allocated to the new volume is undesirably reduced by this amount. According to this embodiment, it is possible to prevent this type of occurrence.

Furthermore, according to the above described embodiment, if it is not possible to add a new volume which satisfies the requested capacity at the physical disk addition time point which has been specified, then a time point at which the requested capacity is satisfied is calculated which is closer to the present than the physical disk addition time point which has been specified, and this time point which has been thus calculated is put forward as the addition time point. By doing this, even if the requested capacity is not satisfied at the physical disk addition time point which has been specified, along with making the addition of a new volume which satisfies this requested capacity possible at once, it is possible to put forward a new addition time point to the manager, in order to prevent in advance the possibility of running out of storage regions, which could arise due to the fact that a new volume has been added.

Although the present invention has been explained above in terms of a preferred embodiment thereof, this embodiment has only been presented by way of example in order to explain the present invention, and it should be understood that the technical range of the present invention is not to be considered as being limited only to this embodiment. The present invention may be embodied in various different other manners.

For example, the volume addition event of the step 5010 of FIG. 18 may be an event which consists of the usage ratio of a volume exceeding a threshold value. In concrete terms, for example, the storage management server 1010 may perform the step 5020 and the subsequent steps if it has decided that the proportion (the usage ratio) of the usage capacity which has been gathered from the host computer 1030 with respect to the allocated capacity has exceeded a threshold value (for example 90%). Furthermore, the physical disk addition time point may also be set in advance, and, in this case, as shown by way of example in FIG. 23, it would also be acceptable to arrange for the storage management server 1010 to make the difference between the required capacity Cp at this physical disk addition time point and the present allocated capacity Cu be the requested capacity of the volume. This requested capacity may be taken as being a capacity for adding to the allocated capacity of the volume which is supplied to the host computer 1030.

Furthermore, for example, the volume information updating program 2150 may, in the step 8090 of FIG. 21, take the other pool as being a pool which has the same attributes as the pool which has been designated. By doing this, even if the storage regions in this other pool shift to the designated pool (in the step 8110), it is possible to prevent storage regions which have different attributes from mixing together within the designated pool, which would be undesirable.

Yet further, for example, it would also be acceptable to arrange for the host computer 1030 and the storage system 1020 not to receive requests from the storage management server 1010, but rather to transmit autonomously the information which the storage management server 1010 takes as being necessary. Even further, it would also be acceptable to arrange for the storage management server 1010 to receive the usage capacity information from the storage system 1020, instead of from a host computer 1030.

Moreover, if the sizes of the storage regions of each of the various storage capacities such as the usage capacity, the allocated capacity, the non-required capacity, the requested capacity, and the like are constant, then it would also be acceptable to describe them by their numbers of storage regions.

Still further, for example, it would also be possible to employ some other structure as the structure for the storage system 1020, instead of the example shown in FIG. 3. For example, there may be included a plurality of first control units (for example control circuit boards) for controlling communication with external devices (for example host computers or other storage systems), a plurality of second control units (for example control circuit boards) for controlling communication with the physical disks 3030, a cache memory which can store data which is transferred between the external devices and the physical disks, a control memory which can store data for controlling the storage system 1020, and a connection unit (for example a switch such as a crossbar switch or the like) which connects together the first control units, the second control units, the cache memory, and the control memory. In this case, one or both of the first control unit and the second control unit may cooperate in order to perform processing as the controller 3010. Furthermore, the control memory may be absent, and, in this case, it would be acceptable to provide a region in the cache memory for storage of the information which formerly was stored in the cache memory.

What is claimed is:

1. A management computer which is communicably connected to one or a plurality of host computers, and to a storage system which comprises a plurality of logical volumes which are supplied to the one or a plurality of host computers, a plurality of physical storage devices, a pool which is made up of a large number of storage regions based on the plurality of physical storage devices, and a controller which allocates storage regions within the pool to logical volumes and cancels such allocations, and writes data according to IO commands for logical volumes which have been specified by the one or a plurality of host computers into storage regions which have been allocated to the logical volumes, or reads out data from the storage regions and transmits the data to the one or a plurality of host computers, the management computer comprising:
a usage capacity reception unit which, for each the logical volume, from at least one of the host computer and the storage system, at a plurality of different time points, receives usage capacity, which is the storage capacity actually used by the host computer, from among the allocated capacity, which is the storage capacity of one or more storage regions which are allocated to the logical volume;
a remaining capacity reception unit which receives, from the storage system, a pool remaining capacity, which is the storage capacity of one or more storage regions which are not allocated to the logical volume, among the large number of storage regions of the pool;
a forecasting unit which, when an event of addition of a logical volume has occurred, forecasts, for at least one logical volume, the usage capacity of the logical volume at a certain time point in the future based on a plurality of usage capacities which have been respectively received at the plurality of time points;
a non-required capacity calculation unit which calculates, for at least one logical volume, a non-required capacity, which is the storage capacity that will not be required at the certain time point, by subtracting from the allocated capacity of the logical volume a required capacity, which is the usage capacity which has been forecast;
a decision unit which, based on the pool remaining capacity which has been received and on the non-required capacity which has been calculated, decides whether or not a requested capacity, which is the storage capacity requested for a logical volume which is the object of addition, is satisfied; and
a command unit which, if a positive decision result is obtained, commands the storage system to cancel storage region allocation equivalent to the non-required capacity which has been calculated, and to allocate storage regions equivalent to the requested capacity and including storage regions of which the allocation is cancelled, to the logical volume which is the object of addition.

2. The management computer according to claim 1, wherein the certain time point is a time point at which the physical storage device is to be additionally provided.

3. The management computer according to claim 1, further comprising:
an addition time point calculation unit which, if a negative decision result is obtained, calculates another time point in the future at which the requested capacity is to be satisfied, as an addition time point which is the time point at which the physical storage device is to be additionally provided; and
an addition time point notification unit which notifies the calculated addition time point to a manager.

4. The management computer according to claim 1, further comprising another decision unit which decides whether or not the accuracy of the forecast required capacity is greater than or equal to a predetermined accuracy,
wherein, when calculating the non-required capacity, the non-required capacity calculation unit uses the required capacity of which the accuracy is greater than or equal to the predetermined accuracy, without using the required capacity of which the accuracy is less than the predetermined accuracy.

5. The management computer according to claim 1, wherein a plurality of pools are provided in the storage system, and
the command unit preferentially cancels the allocation of storage regions equivalent to the non-required capacity within the same pool, and allocates the storage regions to the logical volume which is the object of addition.

6. The management computer according to claim 1, wherein the command unit preferentially cancels the allocation of storage regions equivalent to the non-required capacity, from that logical volume whose non-required capacity is the largest, and allocates the storage regions to the logical volume which is the object of addition.

7. The management computer according to claim 1, wherein a plurality of pools are provided within the storage system, and the command unit preferentially cancels an allocation equivalent to the non-required capacity from storage regions which are allocated to that logical volume whose non-required capacity is the largest, among the storage regions within the same pool, and allocates the storage regions to the logical volume which is the object of addition.

8. The management computer according to claim 1, wherein a plurality of pools are provided within the storage system, and when canceling a storage region allocation equivalent to the non-required capacity within two or more pools from among the plurality of pools and allocating the storage regions to the logical volume which is the object of addition, the command unit treats the two or more pools as pools having the same reliability attribute.

9. The management computer according to claim 1, wherein the storage system comprises a first pool and a second pool, and
the command unit preferentially cancels storage regions equivalent to the non-required capacity of the first pool and allocates the storage regions to the logical volume which is the object of addition, and, if nevertheless the requested capacity is not satisfied and a capacity shortage occurs, then subtracts, from the second pool, at least storage regions equivalent to the capacity shortage among the pool remaining capacity of the second pool and adds the storage regions to the first pool, and allocates the added storage regions to the logical volume which is the object of addition.

10. The management computer according to claim 9, wherein when the requested capacity is not satisfied and a capacity shortage occurs even if the command unit subtracts, from the second pool, storage regions equivalent to the entire pool remaining capacity of the second pool and adds the storage regions to the first pool, then the command unit cancels the allocation of storage regions at least equivalent to the capacity shortage in the second pool, subtracts the canceled storage regions from the second pool and adds the storage regions to the first pool, and allocates the added storage regions to the logical volume which is the object of addition.

11. The management computer according to claim 2, wherein the addition time point calculation unit forecasts, for the plurality of logical volumes, transitions of usage capacity accompanying the passage of time, and calculates the addition time point based on a plurality of transitions which have been forecast for the plurality of logical volumes, respectively.

12. The management computer according to claim 1, wherein the event is a logical volume addition request from a manager, and a requested capacity is included in the logical volume addition request.

13. The management computer according to claim 1, further comprising a usage ratio calculation unit which calculates, for at least one of the plurality of logical volumes, a usage ratio which is the proportion of the usage capacity with respect to the allocated capacity; and wherein
the event means that the calculated usage ratio has exceeded a predetermined usage ratio;
and the decision unit takes the requested capacity as the difference between the required capacity which has been forecast and the allocated capacity.

14. The management computer according to claim 1, further comprising:
another decision unit which decides whether or not the accuracy of the required capacity which has been forecast is greater than or equal to a predetermined accuracy;
an addition time point calculation unit which, if a negative decision result is obtained, calculates another time point in the future at which the requested capacity is to be satisfied as an addition time point, which is the time point at which the physical storage device is to be additionally provided; and
an addition time point notification unit which notifies a manager of the calculated addition time point; and wherein:
the certain time point is the time point at which the physical storage device is to be additionally provided;
when calculating the non-required capacity, the non-required capacity calculation unit uses the required capacity of which the accuracy is greater than or equal to the predetermined accuracy, without using the required capacity of which the accuracy is less than the predetermined accuracy;
and the addition time point calculation unit forecasts, for the plurality of logical volumes, transitions of usage capacity accompanying the passage of time, and calculates the addition time point based on a plurality of transitions which have been forecast for the plurality of logical volumes, respectively.

15. A method for optimizing the allocation of storage regions, implemented on a system comprising: one or a plurality of host computers; and a storage system which comprises a plurality of logical volumes which are supplied to the one or a plurality of host computers, a plurality of physical storage devices, a pool which is made up of a large number of storage regions based on the plurality of physical storage devices, and a controller which allocates storage regions within the pool to logical volumes and cancels such allocations, and writes data according to IO commands for logical volumes which have been specified by the one or a plurality of host computers into storage regions which have been allocated to the logical volumes, or reads out data from the storage regions and transmits the data to the one or a plurality of host computers, the method comprising the steps of:
acquiring, for each the logical volume, usage capacity, which is the storage capacity actually used by the host computer, from among the allocated capacity which is the storage capacity of one or more storage regions which are allocated to the logical volume, at a plurality of different time points;
acquiring pool remaining capacity, which is the storage capacity of one or more storage regions which are not allocated to the logical volume, among the large number of storage regions of the pool;
forecasting, when an event of addition of a logical volume has occurred, the usage capacity of the logical volume at a certain time point in the future, for at least one logical volume, based on a plurality of usage capacities which have been respectively received at the plurality of time points;
calculating, for at least one logical volume, a non-required capacity which is the storage capacity that will not be required at the certain time point, by subtracting from the allocated capacity of the logical volume a required capacity, which is the usage capacity which has been forecast;
deciding whether or not a requested capacity, which is the storage capacity requested for a logical volume which is the object of addition, is satisfied, based on the pool remaining capacity which has been received and on the non-required capacity which has been calculated; and
canceling, if a positive decision result is obtained, storage region allocation equivalent to the non-required capacity which has been calculated, and allocating storage regions equivalent to the requested capacity and including storage regions of which the allocation is cancelled, to the logical volume which is the object of addition.

16. The optimization method according to claim 15, wherein, if a negative decision result is obtained, another time point in the future at which the requested capacity is to be satisfied is calculated as an addition time point which is the time point at which the physical storage device is to be additionally provided; and
the calculated addition time point is notified to a manager.

17. The optimization method according to claim 15, wherein a plurality of pools are provided in the storage system, and
the allocation of storage regions equivalent to the non-required capacity within the same pool is preferentially canceled, and the storage regions are allocated to the logical volume which is the object of addition.

18. The optimization method according to claim 15, wherein the allocation of storage regions equivalent to the non-required capacity is canceled preferentially from that logical volume whose non-required capacity is the largest, and the storage regions are allocated to the logical volume which is the object of addition.

19. A computer program for being executed on a computer which is communicably connected to one or a plurality of host computers which transmit IO commands for logical volumes which are supplied to the host computers, and to a storage system which comprises a plurality of logical volumes which are supplied to the one or a plurality of host computers, a plurality of physical storage devices, a pool which is made up of a large number of storage regions based on the plurality of physical storage devices, and a controller which allocates storage regions within the pool to logical volumes and cancels such allocations, and writes data according to IO commands for logical volumes which have been specified by the one or a plurality of host computers into storage regions which have been allocated to the logical volumes, or reads out data from the storage regions and transmits the data to the one or a plurality of host computers, the program causing the computer to execute:
a process of receiving, for each the logical volume, from at least one of the host computer and the storage system, usage capacity which is the storage capacity actually used by the host computer, from among the allocated capacity, which is the storage capacity of one or more storage regions which are allocated to the logical volume, at a plurality of different time points;
a process of receiving, from the storage system, pool remaining capacity, which is the storage capacity of one or more storage regions which are not allocated to the logical volume, among the large number of storage regions of the pool;
a process of, when an event of addition of a logical volume has occurred, forecasting, for at least one logical volume, the usage capacity of the logical volume at a certain time point in the future, based on a plurality of usage capacities which have been respectively received at the plurality of time points;
a process of, for at least one logical volume, calculating a non-required capacity, which is the storage capacity that will not be required at the certain time point, by subtracting from the allocated capacity of the logical volume a required capacity, which is the usage capacity which has been forecast;
a process of, based on the pool remaining capacity which has been received and on the non-required capacity which has been calculated, deciding whether or not a requested capacity, which is the storage capacity requested for a logical volume which is the object of addition, is satisfied; and
a process of, if a positive decision result is obtained, canceling storage region allocation equivalent to the non-required capacity which has been calculated, and allocating storage regions equivalent to the requested capacity and including storage regions of which the allocation is cancelled, to the logical volume which is the object of addition.

20. A method for optimizing the allocation of storage regions, implemented on a system comprising: one or a plurality of host computers; and a storage system which comprises a plurality of logical volumes which are supplied to the one or a plurality of host computers, a plurality of physical storage devices, a pool which is made up of a large number of storage regions based on the plurality of physical storage devices, and a controller which allocates storage regions within the pool to logical volumes and cancels such allocations, and writes data according to 10 commands for logical volumes which have been specified by the one or a plurality of host computers into storage regions which have been allocated to the logical volumes, or reads out data from the storage regions and transmits the data to the one or a plurality of host computers, the method comprising the steps of:
acquiring, for each the logical volume, usage capacity which is the storage capacity actually used by the host computer, from among the allocated capacity, which is the storage capacity of one or more storage regions which are allocated to the logical volume, at a plurality of different time points;
acquiring pool remaining capacity which is the storage capacity of one or more storage regions which are not allocated to the logical volume, among the large number of storage regions of the pool;
forecasting, when an event of addition of a logical volume has occurred, for at least one logical volume, the usage capacity of the logical volume at an addition time point in the future at which the physical storage device is to be additionally provided, based on a plurality of usage capacities which have been respectively received at the plurality of time points;
deciding whether or not the accuracy of a required capacity, which is the usage capacity which has been forecast, is greater than or equal to a predetermined accuracy;
calculating, for at least one logical volume, a non-required capacity, which is the storage capacity that will not be required at the addition time point, by subtracting from the allocated capacity of the logical volume a required capacity for which the accuracy is greater than or equal to the predetermined accuracy;
deciding whether or not a requested capacity, which is the storage capacity requested for a logical volume which is the object of addition, is satisfied, based on the pool remaining capacity which has been received and on the non-required capacity which has been calculated;
canceling, if a positive decision result is obtained, storage region allocation equivalent to the non-required capacity which has been calculated, and allocating storage regions equivalent to the requested capacity and including storage regions of which the allocation is cancelled, to the logical volume which is the object of addition; and
forecasting, if a negative decision result is obtained, transitions of usage capacity accompanying the passage of time for the plurality of logical volumes, calculating another time point in the future at which the requested capacity is to be satisfied as another addition time point which is the time point at which the physical storage device is to be additionally provided, based on a plurality of transitions which have been forecast for the plurality of logical volumes, respectively, and notifying the other addition time point which has been calculated to a manager.
